(19) United States
(12) Patent Application Publication
(10) Pub. No.: US 2008/0158260 A1
(43) Pub. Date: Jul. 3, 2008

(54) Digital picture display with rotatable display frame

(75) Inventor: Zhong-Ru Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/005,689

(22) Filed: Dec. 28, 2007

(30) Foreign Application Priority Data
Dec. 29, 2006 (TW) 95149721

(51) Int. Cl. G09G 5/00

(52) U.S. Cl. 345/658; 345/649

(57) ABSTRACT

An exemplary digital picture display includes a display panel (220), a supporting element (240), and a control section. The display panel is arranged for displaying digital pictures. The supporting element is arranged for supporting the display panel. The control section is arranged for rotating and scaling a digital picture to match with a resolution of the display panel, and rotating the display panel.

The present invention relates to digital picture displays, and particularly to a digital picture display with rotatable display frame.

### BACKGROUND

As advantages in microprocessor and other related technologies continue to improve the price/performance of various electronic components, a processor-based system, such as a digital camera, an MP3 player, or a personal digital assistant, has been popular in recent years. A digital picture display is a processor-based system that displays pictures, such as digital paintings, family photographs, and the like.

FIG. 4 is an, isometric view of a conventional digital picture display. The digital picture display includes a display panel 120 and a frame 110 used for holding the display panel 120.

FIG. 5 is a circuit diagram of the digital picture display 1 of FIG. 4. The digital picture display 1 further includes an inputting unit 131, a memory 132, a control unit 135, and a microprocessor unit (MPU) 134. The inputting unit 131 is used for receiving digital picture information from external devices. The memory 132 is used for storing the digital picture information. The control unit 135 is electrically connected to the MPU 134, thereby users can input control signals to the MPU 134 via the control unit 135. The MPU 134 is used for receiving digital picture information from the inputting unit 131 or the memory 132, and processing digital picture information. And, the MPU 234 outputs the digital picture information into the display panel 120. The display panel 120 displays a digital picture image according to the digital picture information.

Generally, digital pictures displayed on the digital picture display 1 have various resolutions. The resolution can be expressed as m:n (m represents a value of a horizontal resolution, n represents a value of a longitudinal resolution), such as 4:3, 3:4, 16:9, or 9:16, and the like. However, one display panel 120 only has a fixed resolution, such as one of the 4:3, 3:4, 16:9, 9:16. If a resolution of a digital picture matches with the resolution of the display panel 120, the digital picture can be displayed appropriately. However, if a resolution of a digital picture doesn't match with the resolution of the display panel 120, the digital picture would be compressed or pulled, in order to be fully displayed on the display panel 120. Accordingly, the digital picture is distorted, whereby a display quality of the digital picture is decreased.

Accordingly, what is needed, therefore, is a digital picture display that can overcome the above-described deficiency.

### SUMMARY

In one preferred embodiment, an exemplary digital picture display includes a display panel, a supporting element, and a control section. The display panel is arranged for displaying digital pictures. The supporting element is arranged for supporting the display panel. The control section is arranged for rotating and scaling a digital picture to match with a resolution of the display panel, and rotating the display panel.

Another exemplary digital picture display includes an inputting unit arranged for receiving digital picture information, a processor arranged for processing the digital picture information, a display panel arranged for displaying the digital picture, and a detecting circuit being connected to the processor. The detecting circuit detects the digital picture information, and sends a control signal to the processor. The processor converts the digital picture according to the control signal, in order that the digital picture matches with the display panel.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of a digital picture display according to a first embodiment of the present invention.

FIG. 2 is a block diagram of the digital picture display of FIG. 1.

FIG. 3 is a block diagram of a digital picture display according to a second embodiment of the present invention.

FIG. 4 is an isometric view of a conventional digital picture display.

FIG. 5 is a circuit diagram of the digital picture display of FIG. 4.

### DETAILED DESCRIPTION OF PREFERRED EMBODIMENTS

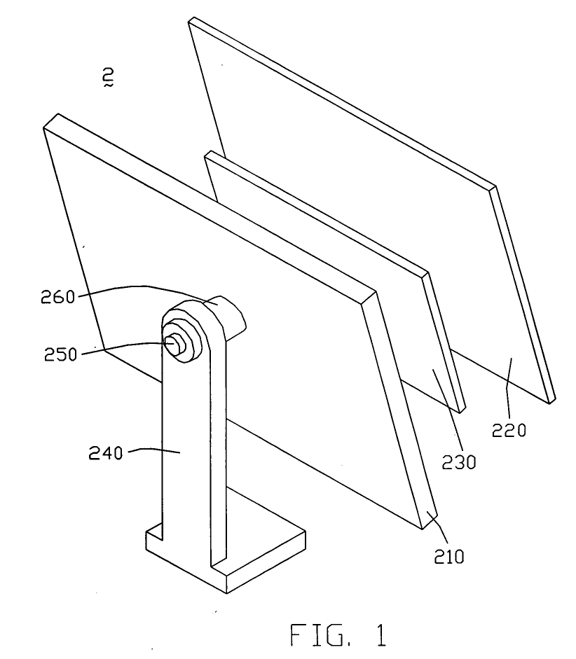

FIG. 1 is an exploded, isometric view of a digital picture display 2 according to a first embodiment of the present invention. The digital picture display 2 includes a display panel 220, a printed circuit board (PCB) 230, a frame 210 used for holding the display panel 220 and the PCB 230, and a supporting member 240 used for supporting the frame 210.

The display panel 220 is used for displaying digital pictures. The display panel 220 can for example be a liquid crystal display (LCD), a plasma display panel (PDP), a light emitting diode (LED) panel, and the like. The display panel 220 has a rectangular structure with a long side and a short side, and has a resolution of m:n (m represents a value of a horizontal resolution, n represents a value of a longitudinal resolution), such as 4:3, 3:4, 16:9, or 9:16, and the like. The frame 210 defines a display window (not labeled). Viewers can see display images through the display window. The frame 210 is connected to an end of the supporting element 240 via a pivot 260 arranged on the frame 210. A motor 250 is arranged at the pivot 260. The motor 250 is able to drive the frame 210 to rotate around the pivot 260.

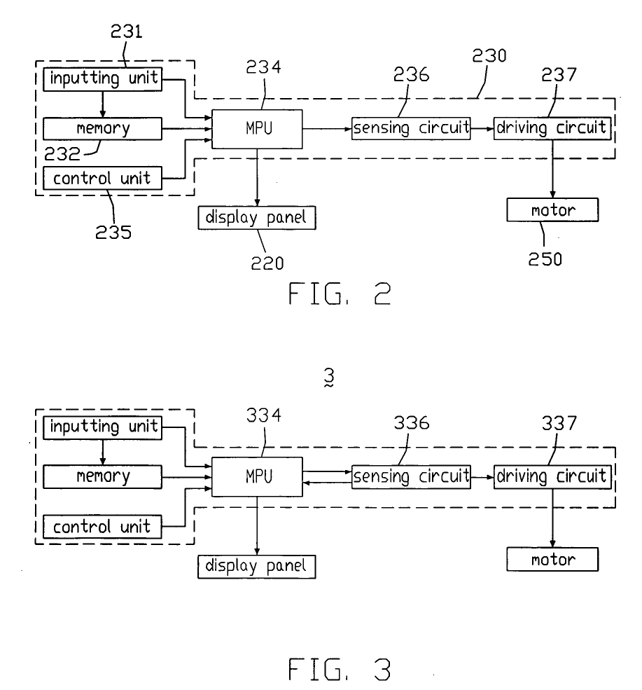

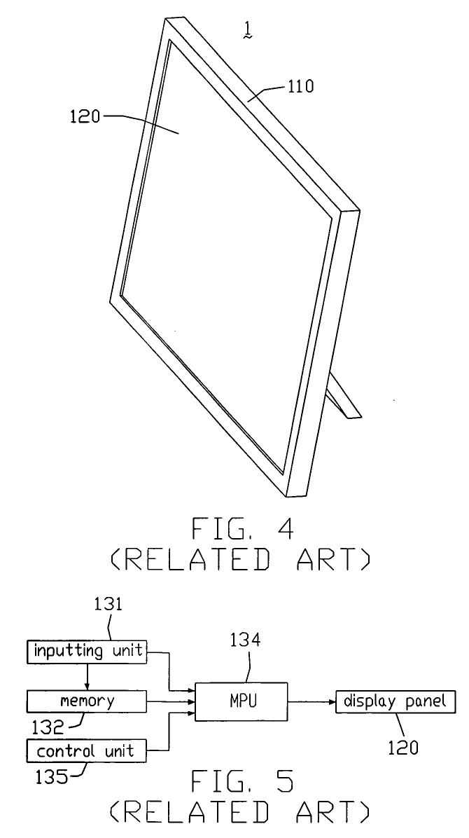

FIG. 2 is a block diagram of the digital picture display of FIG. 1. The PCB 230 includes an inputting unit 231, a memory 232, a control unit 235, a microprocessor unit (MPU) 234, a detecting circuit 236, and a driving circuit 237.

The inputting unit 231 is used for receiving digital picture information from external electronic apparatus. The external electronic apparatus may for example be a compact flash (CF), a XD-picture (XD) card, a multimedia card (MMC), a memory stick (MS), a smart media (SM) card, a secure digital (SD) memory card, and the like. The memory 232 is used for storing digital picture information from the external electronic apparatus. The memory 232 is a non-volatile memory, such as a block erasable flash memory, an electrically erasable programmable read-only-memory (EEPROM), a complementary metal oxide semiconductor (CMOS) memory, and the like.

The control unit 235 is electrically connected to the MPU 234, so that users can input control signals to the control unit 235 to control the digital picture display 2 via a peripheral inputting element (not shown). The peripheral inputting element can for example be inputting keys arranged on the frame 210, a remote controller, and the like. The MPU 234 is used for receiving and scaling digital picture from the inputting unit 231 or the memory 232. Then the MPU 234 outputs the digital picture into the display panel 220. The display panel 220 displays the digital picture. The detecting circuit 236 is used for detecting control signals from the MPU 234 and sending the driving signal to the driving circuit 237. The driving circuit 237 is used for driving the motor 250 to work according to the driving signal.

Generally, a digital picture has resolutions of m:n (m referring a horizontal resolution, n referring a longitudinal resolution), such as 4:3, 3:4, 16:9, or 9:16, and the like. When a digital picture is liable to be displayed, the MPU 234 reads corresponding digital picture information from the memory 232 or the inputting unit 231. Then the MPU 234 scales the digital picture to match with the resolution of the display panel 220, and outputs the digital picture to the display panel 220. Then the display panel 220 displays the digital picture. A viewer can also operate the digital picture display 2 to rotate the display panel 220, in order that the viewers can enjoy the picture comfortably. More detail operation of the digital picture display 2 is described as follows.

Generally, the digital picture display 2 is in an original state with the long side parallel to the horizontal direction. If the MPU 234 receives a digital picture having resolutions of 4:3 or 16:9, the digital picture is directly displayed on the display panel 220.

However, If the MPU 234 receives a digital picture having resolutions of 3:4 or 9:16 which is different from that of the display panel 220, the MPU 234 rotates the digital picture clockwise or counter-clockwise by 90 degrees without distorting the digital picture, and/or scales the digital picture. If the resolution of the digital picture is converse to that of the display panel 220, the digital picture is rotated by 90 degrees. If the resolution of the digital picture is different from that of the display panel 220, the digital picture is scaled to match with the resolution of the display panel 220. Thus, the digital picture matches with the resolution of the display panel 220 appropriately and is fully displayed on the display panel 220. Then viewer can input a control signal to the MPU 234 to rotate the frame 210. The MPU 234 processes the control signal and sends the control signal to the detecting circuit 236. The detecting circuit 236 receives the processed control signal and sends the control signal to the driving circuit 237. Then the driving circuit 237 drives the motor 250 to rotate according to the processed control signal. The motor 250 drives the frame 210 to rotate counter-clockwise or clockwise around the pivot 260 by 90 degrees. The rotation direction of the frame 210 is reverse to that of the digital picture. Such that, the short side of the frame 220 is oriented along the horizontal direction, in order to adapt the resolution of the digital picture. Accordingly, the digital picture is fully displayed at the display panel 220 without any distortion. This helps viewer enjoy the digital picture conveniently.

With the above-described configuration, the MPU 234 rotates and/or scales digital pictures with various resolutions in order to match with the resolution of the display panel 220. And viewers can also input control signals to rotate the frame 210 via the driving circuit 237 and the motor 250. Such that digital pictures with various resolutions can be displayed on the display panel 220 without any distortions. The digital picture display 2 has a high display quality and viewers can enjoy the digital picture conveniently.

FIG. 3 is a circuit diagram of a digital picture display 3 according to a second embodiment of the present invention. The digital picture display 3 has a circuit diagram similar to that of the digital picture display 2. However, when the MPU 334 receives a digital picture, the detecting circuit 336 is able to detect a resolution of the digital picture. If the resolution of the digital picture matches with the resolution of the display panel 320, the digital picture is directly displayed on the display panel 320. If the resolution of the digital picture is different from that of the display panel 320, the detecting circuit 336 sends a first control signal to the MPU 334 to scale or/and rotate the digital picture, in order to match with the resolution of the display panel 320. Simultaneously, the detecting circuit 336 sends a second control signal to the driving circuit 337. Then the driving circuit 337 drives the motor 350 to rotate the display panel 320 by a given amount, according to the second control signal. The digital picture display 3 has functions of both self-detecting and rotating the display panel 320 automatically.

It is to be further understood that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A digital picture display, comprising:
a display panel arranged for displaying a digital picture;
a supporting element arranged for supporting the display panel; and
a control section arranged for rotating and scaling a digital picture to match with a resolution of the display panel, and rotating the display panel.

2. The digital picture display as claimed in claim 1, further comprising an inputting unit arranged for receiving digital pictures.

3. The digital picture display as claimed in claim 2, wherein the control section comprises a microprocessor unit for receiving the digital pictures from the inputting unit, and rotating and/or scaling the digital picture to match with the resolution of the display panel.

4. The digital picture display as claimed in claim 3, wherein the microprocessor unit rotates the digital picture by 90 degrees to match with the resolution of the display panel while a resolution of the digital picture is converse to that of the display panel.

5. The digital picture display as claimed in claim 4, further comprising a frame for holding the display panel, and the frame being connected to the supporting element.

6. The digital picture display as claimed in claim 5, wherein the frame comprises a pivot, and the frame being connected to an end of the supporting element via the pivot.

7. The digital picture display as claimed in claim 6, further comprising a motor, the control section controlling the motor to drive the frame to rotate around the pivot.

8. The digital picture display as claimed in claim 7, further comprising a detecting circuit and a driving circuit, the detecting circuit receives a control signal from the microprocessor unit, and outputs a control signal to the driving circuit, the driving circuit drives the motor to rotate according to the control signal.

9. The digital picture display as claimed in claim 1, further comprising a memory used for storing digital pictures.

10. The digital picture display as claimed in claim 9, wherein the memory is a non-volatile memory.

11. The digital picture display as claimed in claim 10, wherein the memory comprises at least one of the following: an erasable flash memory, an electrically erasable programmable read only memory, and a complementary metal oxide semiconductor memory.

12. A digital picture display, comprising:
an inputting unit arranged for receiving a digital picture;
a processor arranged for processing the digital picture;
a display panel arranged for displaying the digital picture; and
a detecting circuit being connected to the processor,
wherein the detecting circuit detects a resolution of the digital picture, and sends a control signal to the processor, the processor rotates and/or scales the digital picture according to the control signal, in order to match with the resolution of the display panel.

13. The digital picture display as claimed in claim 12, wherein the processor unit rotates the digital picture by 90 degrees to match with the resolution of the display panel while a resolution of the digital picture is different from that of the display panel,

14. The digital picture display as claimed in claim 13, further comprising a frame arranged for holding the display panel, a supporting element arranged for supporting the frame, a pivot connecting the frame and the supporting element, and a motor arranged for driving the frame to rotate around the pivot.

15. The digital picture display as claimed in claim 14, wherein the detecting circuit drives the motor to rotate the frame around the pivot.

16. The digital picture display as claimed in claim 14, further comprising a control unit arranged for inputting control signal to the processor.

17. The digital picture display as claimed in claim 15, further comprising a memory used for storing digital picture information.

18. The digital picture display as claimed in claim 16, wherein the memory is a non-volatile memory.
